(19) United States
(12) Patent Application Publication
(10) Pub. No.: US 2012/0304443 A1
(43) Pub. Date: Dec. 6, 2012

(54) NEAR RIDGED BEAM TO COLUMN CONNECTOR SYSTEM

(76) Inventor: Ivan Glenfield Quail, Perth (AU)

(21) Appl. No.: 13/511,165

(22) PCT Filed: Nov. 26, 2010
(86) PCT No.: PCT/AU2010/001593

§ 371 Date: Aug. 17, 2012

(30) Foreign Application Priority Data
Nov. 27, 2009 (AU) 2009905804

(51) Int. Cl. A47B 96/00; B23P 17/00

(52) U.S. Cl. 29/428; 29/592

(57) ABSTRACT

A method of manufacturing near-rigid connections between beams and columns or posts for use in pallet racking, shelving, channel and z shaped beam to column or post web connections wherein the connectors may be formed from the beam material itself and which may include tangs, teeth, hooks, tines, rivets or other means of engagement of the beam connector with the column or post and wherein the connectors from adjacent beams may be interconnected by a non-integrated load transfer plate to distribute loads over the tangs, teeth, hooks, tines, rivets or fasteners of both beams. Various forms of the invention are disclosed.

This invention relates to improvements in methods of manufacturing near-rigid connections between beams and columns or posts for use in pallet racking, shelving, channel and z shaped beam to column or post web connections wherein the web or face of the column is on the perimeter of the column or post section such as in a substantially channel or angle shaped section and wherein the beams may be of hollow, partially hollow or open sections formed from sheet metal or hot rolled sections and wherein the means of connecting the beams to the columns or posts may be substantially stiffened and wherein part of the beam end moments and or substantially horizontal forces may be transferred across the column or post face or web to the adjacent beam connector plate and beam and wherein part of the bearing loads from the beam end connector plate tangs, teeth, hooks, tines, rivets or other fasteners may be distributed over the tangs, teeth, hooks, tines, rivets or other fasteners of the said adjacent beam connector plate and the adjacent beam to column connection to thus distribute the substantially lateral load from any one beam over a greater number of tangs, teeth, hooks, tines, rivets or other fasteners.

In this description items described in the singular may also be interpreted as having a plural meaning. The word tang or tangs may refer to both preformed affixed rivet type engagement means or to teeth, tines or hooks formed from the connector plate material.

Current methods of manufacturing connections between beams and columns or posts employ a connector which is independently manufactured as a separate entity and a beam which is attached to the beam connector plate by welding or similar means. This method is employed by many rack manufacturers such as for example Dexion, APC, Colby and Brownbuilt.

It has been found that beam connector plates may be formed from the beam material itself thereby eliminating the need to weld connector plates to beam ends. A further benefit of this form of manufacture is that pre-galvanised or pre-coated material may be utilised thus eliminating the need for post weld cleaning and painting or powder coating.

It has further been found that lighter section beams may be utilised provided that a substantially rigid connection can be made between the beam and the column thereby reducing the cost of production. However, substantially rigid connections are not used in practice by shelving and rack manufacturers because of the high degree of difficulty in repeatedly and consistently achieving in mass production the precision manufacturing tolerances that are necessary to form a substantially rigid transverse connection. As a result, current methods of manufacturing connections between beams and columns or posts employ an engineering system known as simple design or semi-rigid design.

In particular, one widely used method of manufacturing connections between beams and columns or posts uses round bolts and rivets as the means of connection. The bolts and rivets are mass produced and due to wear on forming machinery and dies the bolts and rivets are made to a nominal diameter with a manufacturing tolerance. For example, a bolt with a nominal diameter of 12 mm commonly has a shank diameter between 11.3 mm and 12.7 mm

Another commonly used method of manufacturing connections between beams and columns or posts uses punched apertures with engaging tangs, teeth, hooks, tines, rivets or other fasteners.

Both the apertures and the tangs, teeth, hooks, tines, rivets or other fasteners vary in dimensions in mass production due to wear on punches and dies. As with bolted connection systems, substantially rigid transverse connections are not able to be manufactured repeatedly and consistently.

The fact that variability occurs in the dimensions of bolts, rivets, tangs, teeth, hooks, tines, rivets and other fasteners and apertures during mass production is recognised in approved industry standards. For example, Australian Standard AS 4100 specifies that holes should be 2 mm greater in diameter than the nominal bolt diameter to accommodate these imperfections and to permit easy passage of the bolt or rivet through substantially aligned holes.

The consequence of this practical limitation on current methods of manufacture is that it is very difficult to achieve a near rigid bearing type connection, and some rotation of the interconnected members relative to each other is inevitable. At present the way in which this rotation is prevented is by the creation of a friction joint wherein high tensile bolts and nuts are tightened until the two plies being connected are under such great pressure that the friction between the two plies prevents slippage or rotation relative to each other. The disadvantage of this approach is that the nuts and bolts must be tightened to a specific torque using a torque wrench, which is time consuming and cost prohibitive for shelving and other systems that commonly utilise hundreds of individual connections. In addition, the engaging surfaces of the nuts and bolts cannot be painted as this would cause slippage in the connection. Unpainted surfaces are prone to corrosion and do not meet the aesthetic requirement of customers.

The method of manufacture proposed herein utilises novel oblong shaped tangs and novel oblong shaped mating apertures, wherein the oblong shape of the aperture is such that a tight wedge fit is always achieved during engagement of the tang with the aperture. In use in a bearing type connection, rotation of one ply relative to an adjacent ply does not occur thereby providing a near rigid connection between the members.

The novel tangs proposed herein also pass through the beam connector plate to which they are attached and the tangs may have a means of connection at each end i.e. two connection points per tang. This enables non-integrated load transfer plates to be easily and quickly connected to the beam connector plate tangs to enable the moment forces or substantially horizontal forces and the rotational and substantially lateral loads to be partially transferred from the said beam connector plate to a beam connector plate on a separate, adjacent beam, thus distributing said loads over a greater number of tangs. The load transfer plate may have lips formed on one or more edges. The tangs would necessarily need to be slightly longer to accommodate the additional thickness of the load transfer plate.

In a further embodiment a load transfer plate may be located between the connector plate and the web of the column and may be of channel shape to substantially engage the flanges of the column to further distribute tensile or compressive forces across the face of the column, thus reducing the loads on the tangs of any one beam end connector plate.

In a preferred embodiment a packer plate can be affixed to the connector. The tangs thus pass through both the beam connector material and the packer plate combined, significantly increasing the material through which the tangs pass. In a typical connection this would amount to 2×2 mm beam connector material plus a 3 mm packer plate, for a total of 7 mm of effective thickness. This provides significantly more restraint against twisting of the tang in either the vertical or horizontal plane as compared to conventional methods of manufacturing connections between beams and columns

In addition, as the tang may protrude from both sides of the beam it is possible to create a near rigid connection between the ends of adjacent beams to which the column and load transfer plate are connected. This may be achieved without the application of any longitudinal tensile load on the tangs and resultant friction forces between the adjacent members. Moreover, the novel tangs proposed herein have a significantly increased bearing area under lateral bearing loads compared to conventional tangs as used in conventional methods of manufacturing connections between beams and columns

The proposed improvements involve new and inventive steps in the manufacture of racking, shelving, channel and z shaped beam connections wherein the beams may be of hollow box section (single or double flange thickness) or inverted U shape, C section or hollow flange I shape or any other shape which lends itself to this method of manufacture.

The beams may be deformed at the ends to create a substantially flat surface to serve as a connector plate to connect the beam ends to the columns. The edges of said flattened portions may be radiused or in a preferred embodiment a packer plate of suitable thickness may be inserted between the two webs just prior to complete flattening or affixed to one face in order to further enhance the strength of the connector. The packer plate, if used, may be affixed to the beam and may in addition serve to increase the distance between points of application of the substantially lateral loads from the tangs to the webs of the beam connector portion and may increase bearing capacity.

A multiplicity of apertures of suitable shape may be created in the beam connector plate portion of the beam. The apertures in the column and load transfer plate (which substantially match in pitch and spacing that of the tangs in the beam connector plate) may be elongated in the vertical direction to enable passage of the tang and retaining nib (if used), thereby allowing easy installation of the beam connector plate to the column and of the load transfer plate to the beam connectors. Alternatively, the tang may be formed so as to have a cut-out, groove or notch at the appropriate points longitudinally along the length of the tang to engage the column to thus create a means of tang and beam retention and tang and load transfer plate retention.

The load transfer plate may include provision for a safety clip or clips to prevent accidental dislodgement of the transfer plate and beams from the column or post.

One embodiment of the invention described herein utilises separate beam connector plates with tangs formed from the beam connector plate material and wherein some of the tangs protrude inwardly and downwardly to engage mating apertures in the column and wherein some of the tangs protrude outwardly to engage mating apertures in a load transfer plate. In other embodiments of the invention preformed tangs may be affixed at appropriate locations to the beam connector plates and some tangs may be formed from the beam connector plate material and others may be preformed and affixed to the beam connector plate assembly which may be of angle or other suitable shape.

A further embodiment of the invention may be employed wherein each beam end connector has tangs formed from the beam end material itself and a packer plate which may be of angle shape and which has at least one row of tangs.

A further alternate means of connection may be employed wherein the tangs which may protrude from both sides of the connector plate are affixed to the beam connector plates such that one end of a tang which protrudes from the inner face of the beam connector plate engages the column and that portion of the tang which protrudes from the outer face of the beam connector plate engages the load transfer plate located across the outer face of the connector plates and wherein at least one tang in the adjacent beam connector plate engages the load transfer plate. The tangs may be tapered inwardly from top to bottom for at least that portion of the tang which passes through the column face and may be tapered inwardly from bottom to top for at least that portion of the tang which passes through the transfer plate or that portion of the tang which passes through the transfer plate may be partially round. Tangs may be tapered in the longitudinal direction to effect a press fit in the beam connector plate to which it is being affixed. The tang may further have a hardened tip to facilitate punching of apertures in the beam end connector plate and fixing of the tang in one operation.

In a further embodiment of the invention at least the lower portion of the longitudinal edge or end of the said beam connector plate extends across the face of the said column and abuts against the similarly extended edge of the adjacent beam connector plate, and wherein in a further embodiment of the invention the said edges have lips formed on those abutting edges.

No current method of manufacturing connections between beams and the web or face a column or post utilise non-integrated load transfer plates to transfer loads between adjacent beams and oblong shaped tangs that protrude through beam connector plates and may have points of connection at each end. Also, by definition the novel tangs proposed herein are not made of the same material as the beam connector plate, unlike in other methods of manufacturing connections between beams and columns No other method of manufacturing connections between beams and columns utilises flattened beam end connectors plus packer plates in the connection or abutment of connectors.

By utilising the proposed improvements it is possible to achieve near-rigid connections thereby reducing deflection and saving on the weight of materials employed in the manufacture of pallet racking, shelving and other structures.

The above described invention will now be more fully described with reference to the drawings attached and the following description of an example of the invention.

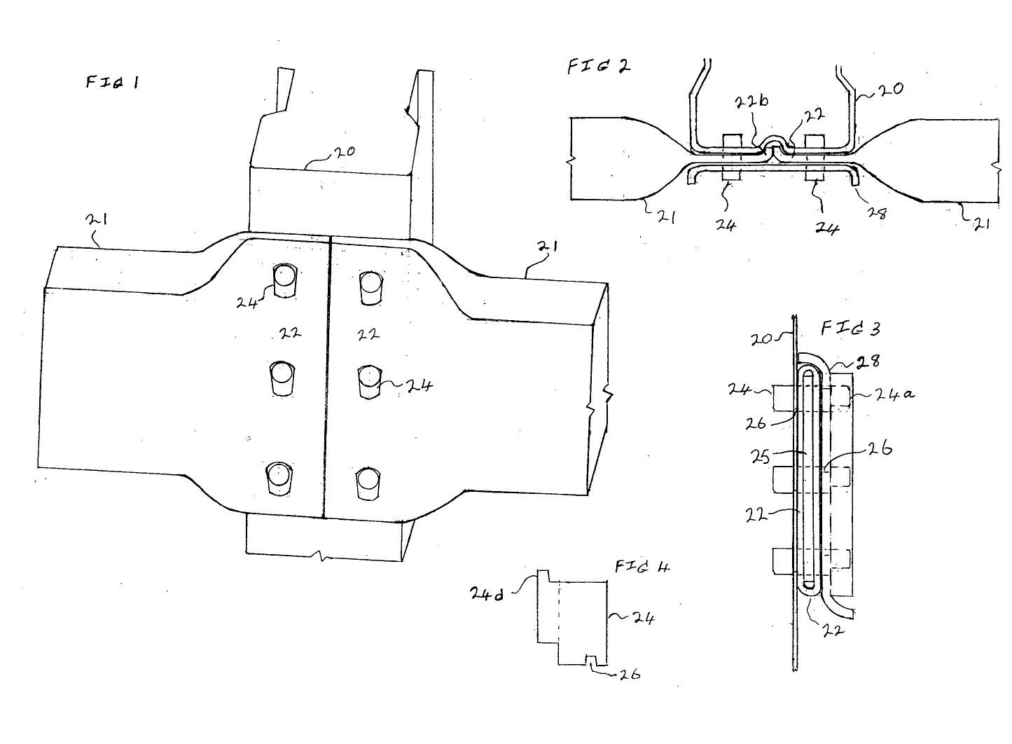

FIGS. 1 and 2 are isometric and plan views respectively of one example of the invention in which the beam connector plates (22) of adjacent beams (21a and b) created, for example, by deforming the end of a rectangular hollow section beam or box beam (21) to form a substantially flat plate (22), the thickness of which may be the combined thickness of the flattened beam end and packer plate (if used). The said flat plate portion (22) of the beam would be of sufficient width to accommodate at least one row of tangs, teeth, hooks, rivets or other fasteners (24) which may be of oblong shape at a suitable pitch to match or coincide with the pitch of the mating apertures in the column or post face or web to which the beam or beams are to be attached. The ends of the beam connector plate (22) with or without internal packer plate may be bent over as shown (22b).

FIG. 3 is another example of the invention showing an end view of a single beam end connector plate (22) with tangs (24) which may be of oblong shape in the vertical direction affixed to the beam connector plate (22) in such a manner as to protrude from both sides of the beam connector plate. The tang or tangs may then pass through the mating apertures in the column to engage the internal face of the column or post (20) under the force of gravity and be retained in said location by engagement of the column face within a preformed groove (26) in the tang (24) near the end of the tang. A load transfer plate (28) attached to the outwardly protruding part of the tang or tangs in adjacent connectors (22) may transfer part of the substantially lateral load to the adjacent tang (24) or tangs in the adjacent beam end connector plate (22). At the beginning and end of a run of racking a beam connector plate (22) or suitable substitute end plate without attached beam may abut the adjacent beam connector plate (22) and transfer load from the transfer plate (28) through the tangs to said beam connector plate (22) or suitable substitute end plate and then to the column or post (20).

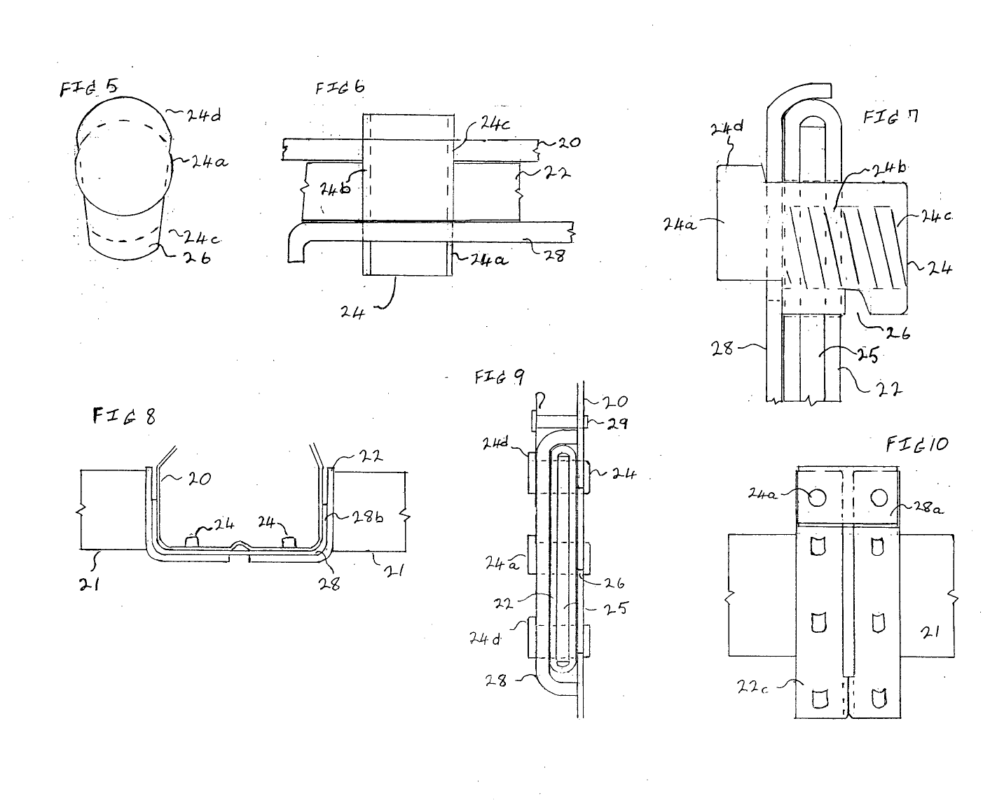

FIGS. 4, 5 and 6 are side, end, and plan views respectively of a preformed tang (24) wherein the sides are tapered inwardly from the top to the bottom over that length of the tang (24c) which passes through the column (20) and may be so for that portion (24b) of the tang which may be affixed to the beam connector plate (22). Thereafter the tang taper may be reversed in direction to taper from the top outwardly to the bottom (24a) for that portion of the length of the tang which passes through a transfer plate, or that portion (24a) of the tang may be partially round to accommodate minor misalignment between adjacent connector tangs and the apertures of substantially mating configuration in the transfer plate.

FIG. 7 is an end view of a beam connector plate showing a tang (24) with one end having a nib (24d) to engage the column through the aperture in the column and the opposite end of the tang which may have a preformed groove or notch (26) at the outer end of the tang (24) to retain the load transfer plate (28) or the tang may be fitted in a vice versa manner.

FIG. 8 is a further example of the utilisation of a load transfer plate (28) which may be located between the beam connector plate and the column in which the hooks or teeth have been so formed or rivets or tangs affixed thereto, so as to extend through apertures in the load transfer plate (28), located between the connector plate and the column web which may have a channel shape such that the flanges (28b) substantially engage the flanges of the column (20) thus distributing substantially lateral loads from, for example, the left hand connector to the right hand connector or vice versa, and further may transfer part of the load to the right hand or left hand flange of the column (20). An outer load transfer plate (28) as shown in FIGS. 9 and 10 may additionally be employed.

FIG. 9 is an end view of another example of the invention wherein the preformed tangs (24) protrude from both sides of the beam connector plate (22) such that the slot (26) and inwardly and downwardly tapered sides of the tang may engage the apertures in the column (20) and the outer protrusion of the tang or tangs (24a) with retainer nib (24d) or further slot (26) over which the load transfer plate (28) may be fitted. The tangs (24) may be tapered inwardly from bottom to top for that portion of the tang length which passes through the load transfer plate such that the narrowest portion of the taper is at the upper region of the tang.

Alternatively, tangs may be formed from the beam end connector material (22) and packer plate (25) combined for connection to the column and additional outwardly protruding teeth or hooks may be formed or tangs or rivets may be affixed to the beam connector plate (22) to transfer forces from the beam connector plate to a load transfer plate (28).

At least one safety retention clip (29) may be attached such that a spring loaded locator pin or tang enters a preformed aperture in the column to prevent accidental dislodgement of the beam connector plates.

FIG. 10 is a front view of separately manufactured beam connector plates affixed to the ends of beams (21) wherein at least one outwardly protruding tang (24a) (which may be round or of oblong shape and with tapered sides as previously described) has been affixed to each connector plate and to which a shorter transfer plate (28a) which engages at least one tang in each of the adjacent connectors may be fitted to transfer part of the substantially horizontal forces to the tang in the adjacent beam connector plate, and further in which at least the lower portion (22c) of the inside longitudinal edge of the beam end connector plate has been extended horizontally across the column face to engage a similar extension of the opposite hand beam connector longitudinal edge such that in use the two edges of the pair of connectors will abut each other. The aforementioned edges may have formed lips. Alternately, a further transfer plate (28a) with tangs (24a) may be employed at the lower end of the connectors.

Various forms of the invention and combinations thereof will be apparent to the skilled addressee.

It will be understood that modifications to the system that would be apparent to the skilled addressee are within the scope of the present invention.

1. A method of manufacturing detachable connections for pallet rack, shelving, channel and z section beams wherein the connection is between a beam connector plate and a web or face of a column and wherein said web is the outer face of the column and wherein the rigidity and strength of the connection is substantially enhanced by the use of one or more of a non-integrated load transfer plate that transfers load to an adjacent separate beam connector plate and wherein oblong shaped tangs, teeth, hooks, tines, rivets or other fasteners which pass through the beam connector plate and which have a means of connection at each end, to engage said column web on one side and the aforementioned load transfer plate on the other side and wherein said beam connector plate is formed from the beam material itself with an optional packer plate attached, and wherein a beam connector plate is located in use so as to abut against an adjacent beam connector plate.

2. A method of manufacturing detachable connections for pallet rack, shelving, channel and z shaped beams according to claim 1 wherein the said load transfer plate is employed to transfer part of the moment or substantially horizontal loads from the said beam connector plate to the said adjacent separate beam connector plate to thus distribute the load from the first connector plate over at least one of the tangs, teeth, hooks, tines, rivets or other fasteners of the said adjacent beam connector plate and wherein part of said loads is, in one embodiment of the invention, further transferred to a beam connected to the said adjacent separate beam connector plate.

3. A method of manufacturing detachable connections for pallet rack, shelving, channel and z shaped beams according to any of claims 1 and 2 wherein the said tangs, teeth, hooks, tines, rivets or other fasteners are affixed to the said beam end connector plate which is formed from the beam material itself with a packer plate or further connector plate attached to the said beam end to provide a means of transferring load from the said beam connector plate to the column and to the said load transfer plate and then the said adjacent beam connector plate.

4. A method of manufacturing detachable connections for pallet rack, shelving, channel and z shaped beams according to any of claims 1 to 3 wherein the said tangs, teeth, hooks, tines, rivets or other fasteners affixed to the said beam connector plate protrude from both sides of the beam connector plate to engage the said column on one side of the beam connector plate and the said load transfer plate on the opposite face or side of the said beam connector plate.

5. A method of manufacturing detachable connections for pallet rack, shelving, channel and z shaped beams according to any of claims 1 to 4 wherein said tangs, teeth, hooks, tines, rivets or other fasteners are preformed to have flat sides, a retaining nib and a substantially oblong or oval shape.

6. A method of manufacturing detachable connections for pallet rack, shelving, channel and z shaped beams according to any of claims 1 to 5 wherein a flat side of said tangs, teeth, hooks, tines, rivets or other fasteners tapers inwardly from top to bottom for at least that part of its length which passes through apertures in the said column and wherein the direction of taper reverses inwardly from bottom to top for that portion of its length which passes through apertures in the said load transfer plate to achieve a wedge type fit in the apertures in the load transfer plate and the column.

7. A method of manufacturing detachable connections for pallet rack, shelving, channel and z shaped beams according to any of claims 1 to 6 wherein said tangs, teeth, hooks, tines, rivets or other fasteners are trapezoid shaped and have a slot or notched segment such that the said load transfer plate or the said column engages the slot or notched segment and is thereby locked in position.

8. A method of manufacturing detachable connections for pallet rack, shelving, channel and z shaped beams according to any of claims 1 to 7 wherein the said slot or notched segment has one outward side tapered inwardly to accommodate different thicknesses of metal of said load transfer plate or said column.

9. A method of manufacturing detachable connections for pallet rack, shelving, channel and z shaped beams according to any of claims 1 to 8 wherein the portion of the said tangs, teeth, hooks, tines, rivets or other fasteners which engage the said column are oriented oblique to the vertical axis either to the left or to the right and wherein the said column has mating apertures in the column face which are also oriented oblique to the vertical axis either to the left or to the right to ensure engagement between said tangs, teeth, hooks, tines, rivets or other fasteners and said apertures.

10. A method of manufacturing detachable connections for pallet rack, shelving, channel and z shaped beams according to any of claims 1 to 9 wherein outwardly protruding tangs, teeth, hooks or tines are formed from the beam material itself plus packer plate combined such that the tangs, teeth, hooks or tines extend through mating apertures in the load transfer plate.

11. A method of manufacturing detachable connections for pallet rack, shelving, channel and z shaped beams according to any of claims 1 to 10 wherein the said beam connector plates have at least one row of inwardly protruding tangs, teeth, hooks, tines, rivets or other fasteners to engage apertures in the said column and wherein said beam connector plate also has at least one outwardly protruding tang, tooth, hook, tine, rivet or other fastener to which said load transfer plate is affixed in order to transfer part of said load to an adjacent separate beam connector plate.

12. A method of manufacturing detachable connections for pallet rack, shelving, channel and z shaped beams according to any of claims 1 to 11 wherein at least the lower portion of the longitudinal edge or end of the said beam connector plate assembly extends across the face of the said column and abuts against the similarly extended edge of the said adjacent beam connector plate, and wherein in one embodiment of the invention the said edges have lips formed on those abutting edges.

13. A method of manufacturing detachable connections for pallet rack, shelving, channel and z shaped beams substantially as herein described with reference to the accompanying drawings.
